(19) United States
(12) Patent Application Publication
(10) Pub. No.: US 2007/0074377 A1
(43) Pub. Date: Apr. 5, 2007

(54) Magnetic paper clip structure

(76) Inventor: Michael Wu, Taipei (TW)

Correspondence Address: BRUCE H. TROXELL, SUITE 1404, 5205 LEESBURG PIKE, FALLS CHURCH, VA, 22041, US

(21) Appl. No.: 11/240,491

(22) Filed: Oct. 3, 2005

(51) Int. Cl. B42F 1/00

(52) U.S. Cl. 24/67 R

(57) ABSTRACT

A magnetic paper clip structure including two magnetic bodies attractable by each other. Each magnetic body has an outer face and an inner face. A substrate is overlaid on the outer faces of the two magnetic bodies. The substrate has a weakened section bridged between the two magnetic bodies, whereby the magnetic bodies can be folded about the weakened section to attract each other or unfolded about the weakened section to separate from each other. An adhesive layer is laid on a back face of the substrate for adhering the magnetic paper clip to any position. At least one irony layer is disposed between the substrate and the magnetic bodies. Another magnetic article can attract the irony layer to fix memos between the front face of the substrate and the magnetic article.

### BACKGROUND OF THE INVENTION

The present invention is related to a soft magnet, and more particularly to a magnetic paper clip structure including an adhesive layer and an irony layer.

A soft magnet is generally made of a composite material composed of a mixture of rubber and plastic and ferric oxide added to the mixture. Pulse current is fed to a magnetic conductive tray with different magnetizing regions for inducing magnetic poles with different polarities on the surface of substrate material. The above magnetizing operation is performed at least once to form a flexible soft magnet which can attract and attach to an attractable article such as an iron-made article. The back face or the other face of the soft magnet can be printed with a trademark or advertising pictures/characters. The soft magnet can be used to manufacture a bookmark or a paper clip. For example, Taiwanese Patent Application No. 92220919 discloses a magnetic paper clip structure. Taiwanese Patent Application No. 92220262 discloses a magnetic bookmark.

When keying in papers, the soft magnet is hard to be fixed in a position near the panel for holding the papers. Practically, other fixing measures such as a computer paper holder is often used to hold the papers. The computer paper holder occupies much room and is inconvenient to use.

Therefore, it is tried by the applicant to provide a magnetic paper clip structure which can be easily directly fixed on a computer panel or the like for clipping papers. In addition, memos can be also fixed on the magnetic paper clip.

### SUMMARY OF THE INVENTION

It is therefore a primary object of the present invention to provide a magnetic paper clip structure including two magnetic bodies attractable by each other. Each magnetic body has an outer face and an inner face. A substrate is overlaid on the outer faces of the two magnetic bodies. The substrate has a weakened section bridged between the two magnetic bodies, whereby the magnetic bodies can be folded about the weakened section to attract each other or unfolded about the weakened section to separate from each other. An adhesive layer is laid on a back face of the substrate for adhering the magnetic paper clip to any position of a compute panel or the like without occupying much room.

It is a further object of the present invention to provide the above magnetic paper clip structure in which at least one irony layer is disposed between the inner face of the substrate and the magnetic bodies. Another magnetic article can attract the irony layer to fix memos between the front face of the substrate and the magnetic article.

It is still a further object of the present invention to provide the above magnetic paper clip structure which is integrally formed. The magnetic paper clip structure has a pair of opposite attractive faces and a pair of opposite non-attractive faces. A substrate is overlaid on the non-attractive faces of the magnetic paper clip. The substrate has a weakened section, whereby the magnetic paper clip can be folded about the weakened section to make the attractive faces attract each other or unfolded about the weakened section to separate the attractive faces from each other.

The present invention can be best understood through the following description and accompanying drawings wherein:

### BRIEF DESCRIPTION OF THE DRAWINGS

FIG. 1 is a perspective view of a first embodiment of the present invention;

FIG. 2 is a perspective view according to FIG. 1, showing that the releasable layer is released from the adhesive layer;

FIG. 3 is an enlarged view of the circled area of FIG. 2;

FIG. 4 shows that the present invention is adhered to a periphery of a computer;

FIG. 5 is a perspective view of a second embodiment of the present invention;

FIG. 6 is a sectional view of the second embodiment of the present invention;

FIG. 7 shows that the present invention is adhered to a periphery of a computer, in which a magnetic article attracts the magnetic paper clip to fix memos thereon;

FIG. 8 is a perspective view of a third embodiment of the present invention;

FIG. 9 is a sectional view of the third embodiment of the present invention;

FIG. 10 is a perspective view of a fourth embodiment of the present invention;

FIG. 11 is a sectional view of the fourth embodiment of the present invention;

FIG. 12 is a perspective view of a fifth embodiment of the present invention; and

FIG. 13 is a sectional view of the fifth embodiment of the present invention.

### DETAILED DESCRIPTION OF THE PREFERRED EMBODIMENTS

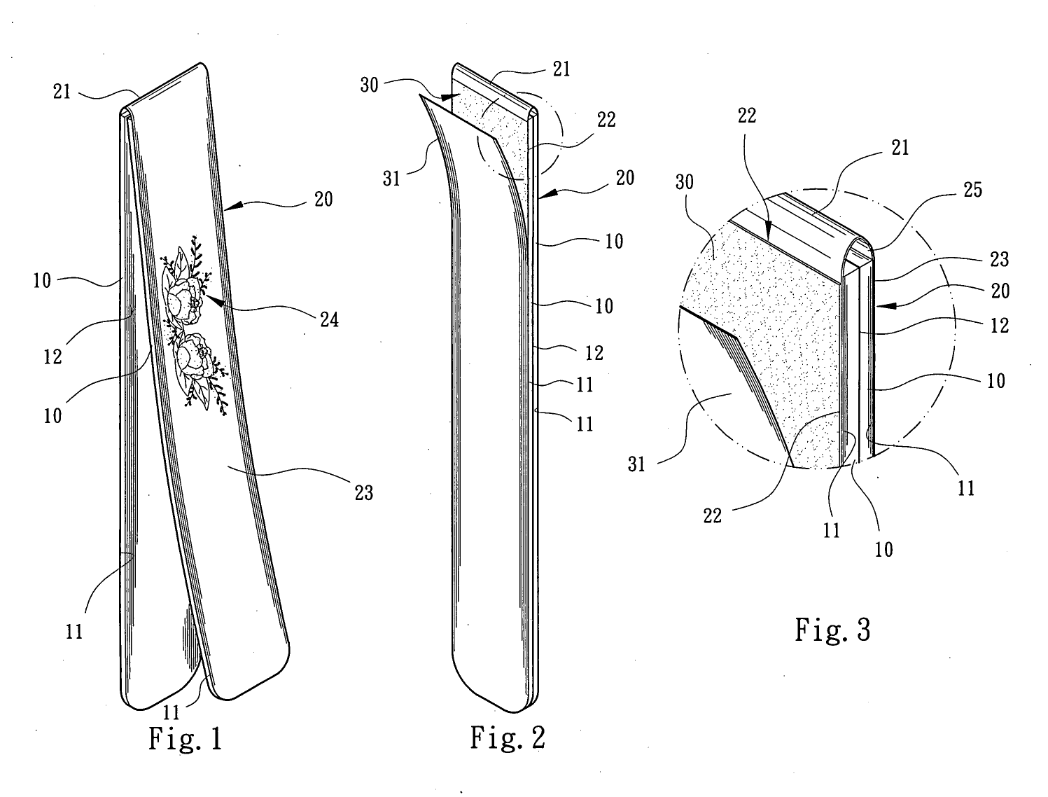

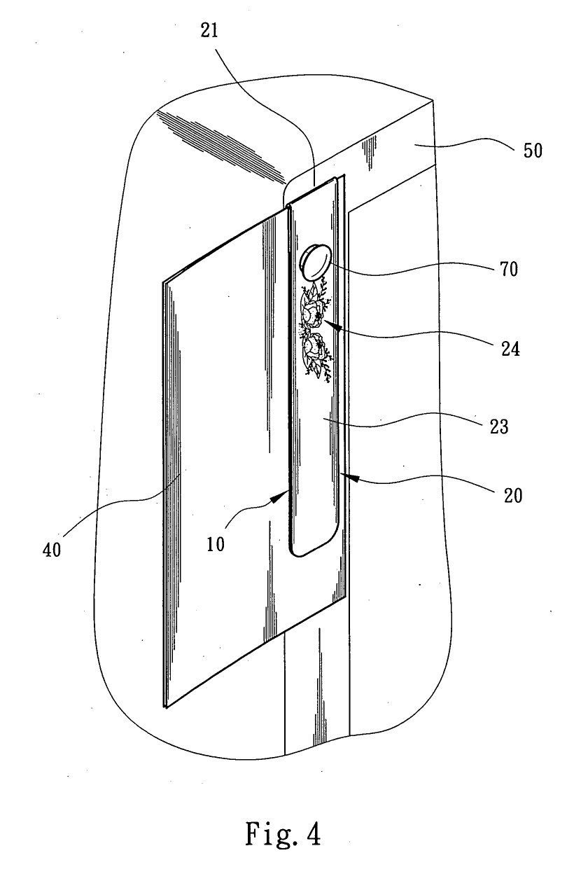

Please refer to FIGS. 1 to 3. The magnetic paper clip of the present invention has two magnetic bodies 10 attractable by each other. Each magnetic body 10 has an outer face 11 and an inner face 12. A substrate 20 is overlaid on the outer faces 11 of the two magnetic bodies 10. The substrate 20 has a weakened section 21 bridged between the two magnetic bodies 10, whereby the magnetic bodies 10 can be folded about the weakened section 21 to attract each other or unfolded about the weakened section 21 to separate from each other. A front face 23 of the substrate 20 can be pressed with a trademark or figure/character section 24 which can be an embossed solid texture. An adhesive layer 30 is laid on a back face 22 of the substrate 20. In a preferred embodiment, a releasable layer or releasable plastic membrane 31 is detachably overlaid on the adhesive layer 30. After the releasable plastic membrane 31 is removed, by means of the adhesive layer 30, the magnetic paper clip can be directly adhered to any position of a computer panel 50 or the like as shown in FIG. 4. At this time, the magnetic paper clip can clip papers without occupying much room.

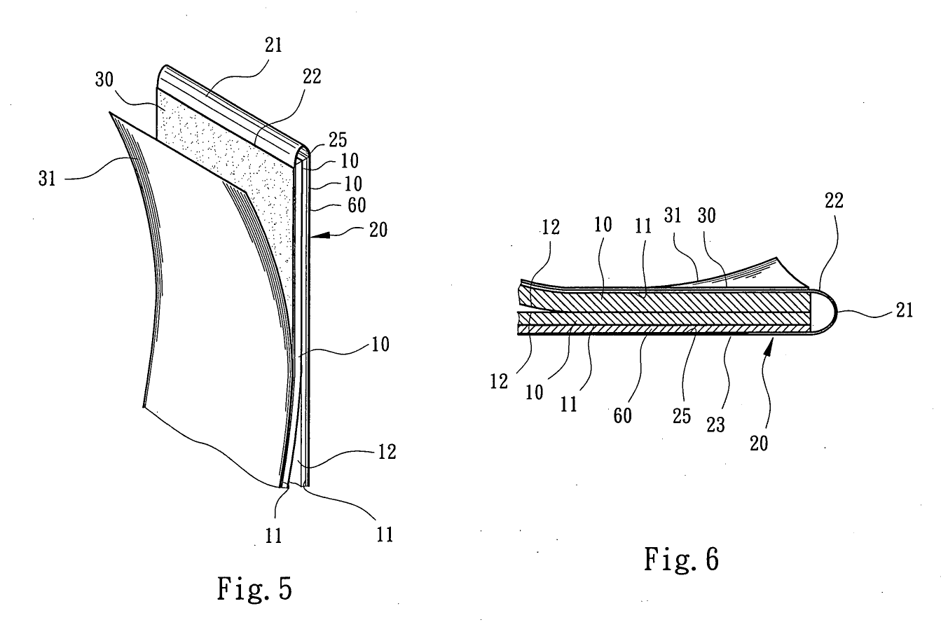

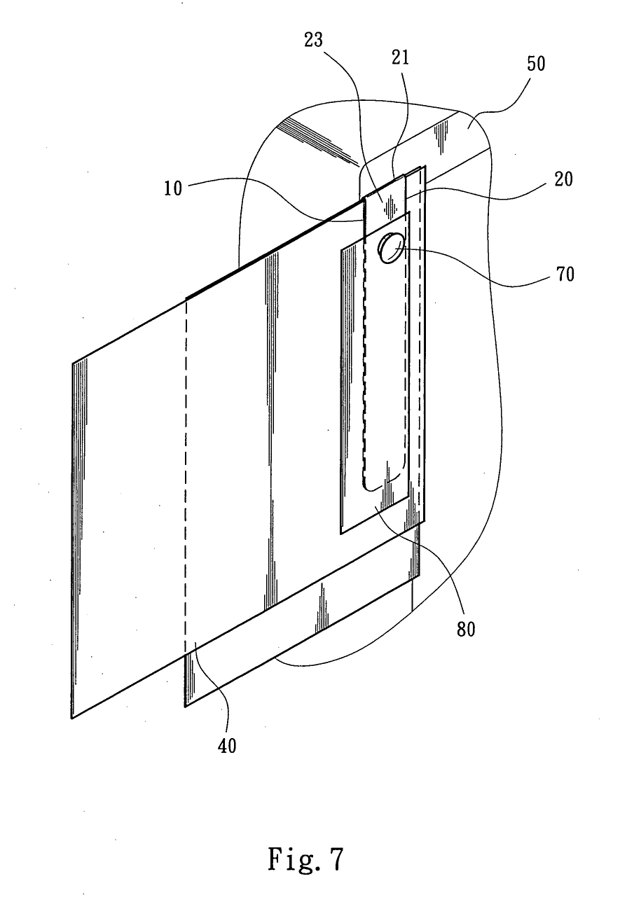

FIGS. 5 and 6 show another embodiment of the present invention. The magnetic paper clip has two magnetic bodies 10 attractable by each other. Each magnetic body 10 has an outer face 11 and an inner face 12. A substrate 20 is attached to the outer faces 11 of the two magnetic bodies 10. The substrate 20 has a weakened section 21 bridged between the two magnetic bodies 10. An adhesive layer 30 is laid on a back face 22 of the substrate 20. A releasable layer or releasable plastic membrane 31 is detachably overlaid on the adhesive layer 30. At least one irony layer 60 is disposed between an inner face 25 of the substrate 20 and the magnetic body 10. In this embodiment, the irony layer 60 is a mixture of iron powder, rubber and resin or the like, whereby the irony layer 60 is a soft layer. However, alternatively, the irony layer 60 can be a hard layer. Another magnetic article 70 can attract the irony layer 60 to fix memos 80 between the front face 23 of the substrate 20 and the magnetic article 70 as shown in FIG. 7.

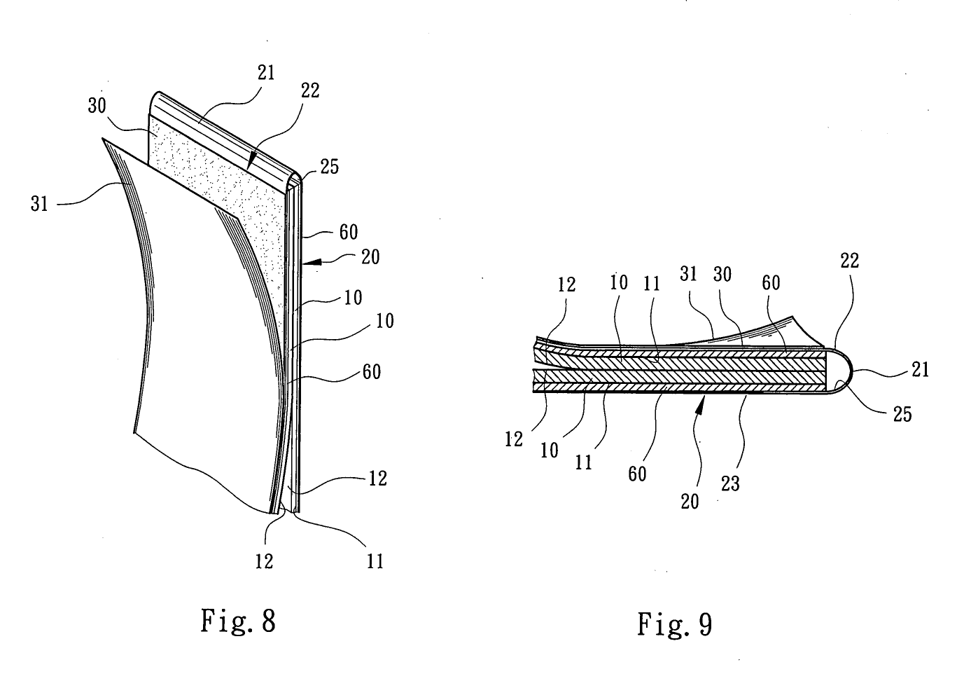

FIGS. 8 and 9 show still another embodiment of the present invention, in which two irony layers 60 are symmetrically disposed between the inner faces 25 of the substrate 20 and the two magnetic bodies 10.

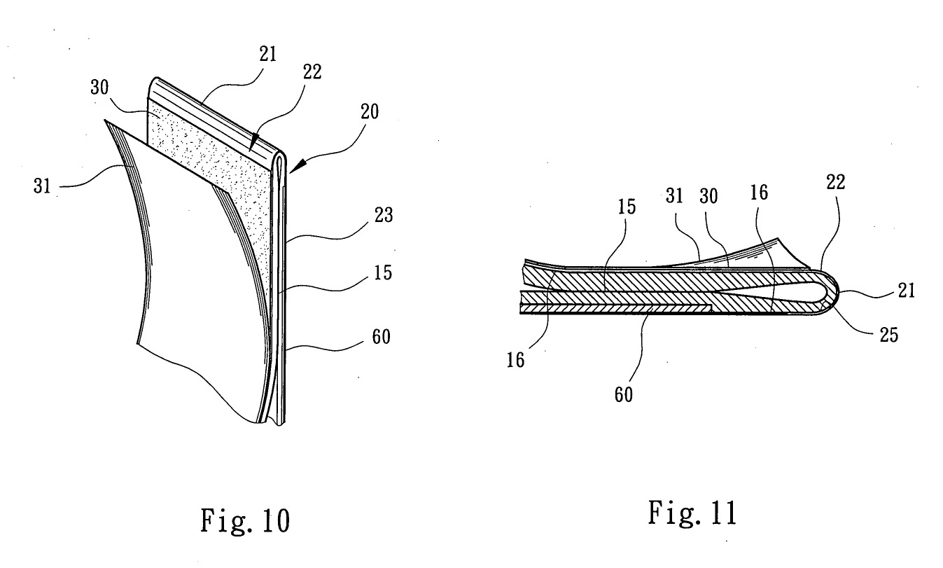

FIGS. 10 and 11 show still another embodiment of the present invention, in which the magnetic paper clip is integrally formed. The magnetic paper clip has a pair of opposite attractive faces 15 and a pair of opposite non-attractive faces 16. A substrate 20 is overlaid on the non-attractive faces 16 of the magnetic paper clip. The substrate 20 has a weakened section 21. The magnetic paper clip can be folded about the weakened section 21 to make the attractive faces 15 attract each other. Also, the magnetic paper clip can be unfolded about the weakened section 21 to separate the attractive faces 15 from each other. An adhesive layer 30 is laid on a back face 22 of the substrate 20. A releasable layer or releasable plastic membrane 31 is detachably overlaid on the adhesive layer 30. In this embodiment, a predetermined part of the non-attractive face 16 is removed along the inner face 25 of the substrate 20, whereby an irony layer 60 is disposed between the non-attractive face 16 and the inner face 25 of the substrate 20.

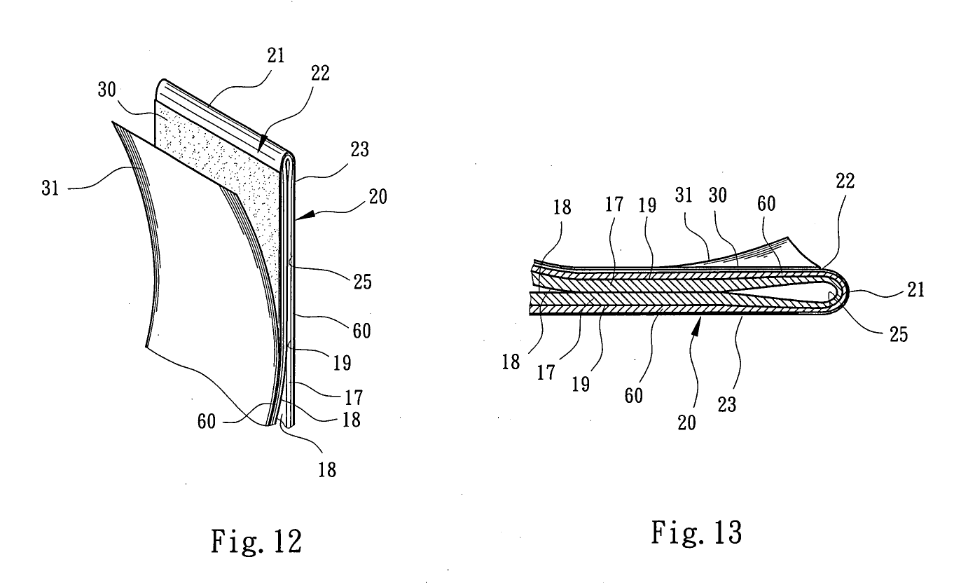

FIGS. 12 and 13 show still another embodiment of the present invention, in which the magnetic paper clip has a foldable magnetic layer 17 having two inner faces 18 attractable by each other and two outer faces 19. An irony layer 60 is overlaid on the outer faces 19 of the magnetic layer 17. A substrate 20 having a weakened section 21 is overlaid on the irony layer 60. An adhesive layer 30 is laid on a back face 22 of the substrate 20. A releasable layer or releasable plastic membrane 31 is detachably overlaid on the adhesive layer 30. FIG. 13 shows that the irony layer 60 is sandwiched between the inner face 25 of the substrate 20 and the magnetic layer 17.

The above embodiments are only used to illustrate the present invention, not intended to limit the scope thereof. Many modifications of the above embodiments can be made without departing from the spirit of the present invention.

What is claimed is:

1. A magnetic paper clip structure comprising:
two magnetic bodies attractable by each other, each magnetic body having an outer face and an inner face;
a substrate overlaid on the outer faces of the two magnetic bodies, the substrate having a weakened section bridged between the two magnetic bodies, whereby the magnetic bodies can be folded about the weakened section to attract each other or unfolded about the weakened section to separate from each other;
an adhesive layer laid on a back face of the substrate; and
a releasable layer or releasable plastic membrane detachably overlaid on the adhesive layer.

2. The magnetic paper clip structure as claimed in claim 1, wherein the substrate has a front face pressed with a trademark or figure/character section.

3. The magnetic paper clip structure as claimed in claim 1, wherein at least one irony layer is disposed between an inner face of the-substrate and the magnetic bodies.

4. The magnetic paper clip structure as claimed in claim 1, wherein two irony layers are symmetrically disposed between the inner face of the substrate and the two magnetic bodies.

5. A magnetic paper clip structure which is integrally formed, the magnetic paper clip structure comprising:
a pair of opposite attractive faces and a pair of opposite non-attractive faces;
a substrate overlaid on the non-attractive faces of the magnetic paper clip, the substrate having a weakened section, whereby the magnetic paper clip can be folded about the weakened section to make the attractive faces attract each other or unfolded about the weakened section to separate the attractive faces from each other;
an adhesive layer laid on a back face of the substrate; and
a releasable layer or releasable plastic membrane detachably overlaid on the adhesive layer.

6. The magnetic paper clip structure as claimed in claim 5, wherein the substrate has a front face pressed with a trademark or figure/character section.

7. The magnetic paper clip structure as claimed in claim 5, wherein a predetermined part of the non-attractive face is removed along the inner face of the substrate, whereby an irony layer is disposed between the non-attractive face and the inner face of the substrate.

8. A magnetic paper clip structure comprising:
a foldable magnetic layer having two inner faces attractable by each other and two outer faces;
a substrate overlaid on the outer faces of the magnetic layer, the substrate having a weakened section;
an adhesive layer laid on a back face of the substrate; and
a releasable layer or releasable plastic membrane detachably overlaid on the adhesive layer.

9. The magnetic paper clip structure as claimed in claim 8, wherein the substrate has a front face pressed with a trademark or figure/character section.

10. The magnetic paper clip structure as claimed in claim 8, wherein an irony layer is overlaid on the outer faces of the magnetic layer.

11. The magnetic paper clip structure as claimed in claim 10, wherein the irony layer is sandwiched between the inner face of the substrate and the magnetic layer.
